(19) United States
(12) Patent Application Publication
(10) Pub. No.: US 2010/0001084 A1
(43) Pub. Date: Jan. 7, 2010

(54) Air Conditioning Equipment

(76) Inventors: Andrei Tres, Sao Paulo-SP (BR); Cintia Abdelnur Lopes, Joinville (BR); Rogerio Soares Brisola, Joinville SC (BR)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/167,279

(22) Filed: Jul. 3, 2008

(30) Foreign Application Priority Data
Jul. 2, 2008 (BR) P10702953-5

(51) Int. Cl. F24F 3/14; B05B 7/32; F25D 17/06

(52) U.S. Cl. 236/44 C; 239/338; 62/426

(57) ABSTRACT

The present invention relates to air conditioning equipment capable of controlling the level of relative air humidity through a closed-loop system, enabling a stable relative air humidity level to be obtained for a pre-adjusted value. Thus, the present application describes air conditioning equipment comprising at least one cooling system and a humidification module associated to each other, said humidification module characterized by being removably built-in to the air conditioning equipment and by being controllable independently from the cooling system through at least one electronic sub-module.

### CROSS-REFERENCE TO RELATED APPLICATIONS

This application claims priority to Brazilian Patent Application No. P10702953-5 filed Jul. 5, 2007, entitled “Air Conditioning Equipment”, the entire disclosure of which is incorporated herein by reference.

### FIELD OF THE INVENTION

The present invention relates to air conditioning equipment which is able to control relative air humidity in indoor environments. More particularly, the present invention relates to air conditioning equipment having a built-in humidification module comprising at least one atomizing element which, when activated, increases the level of relative air humidity of an indoor environment by nebulizing a certain amount of water.

### BACKGROUND OF THE INVENTION

### Description of the Prior Art

Normally, the basic internal structure of air conditioning equipment comprises at least one evaporator, one condenser, one compressor, an expansion valve and fans, in addition to the pipes and fins. These elements form a cooling circuit through which a fluid flows so as to enable the temperature of an indoor environment to be decreased, by removing the heat from this environment and moving it to an outdoor environment through the constitutive elements of the air conditioner involved.

### The Cooling Circuit

The fluid which circulates through the cooling circuit usually follows the following sequence: compressor, condenser, expansion valve, evaporator, and back to the compressor, thus forming a closed cycle. During the circulation, the fluid undergoes pressure and temperature variations, which are responsible for the alteration of its state, which can be gaseous or liquid. A brief description of the main constitutive elements of the cooling system of the air conditioner is provided below, with emphasis on the cycle of the fluid which passes through them:

The compressor increases the pressure of the fluid which passes through it and, consequently, the temperature of said fluid is also increased. In the compressor, the fluid is in the gaseous state (both when it goes in and when it comes out);

In the condenser, the fluid coming from the compressor is cooled and condensed. This is also where the heat exchange with the outdoor environment occurs, with the latter absorbing the hot air present around the condenser. An axial fan can aid in this process, expelling the air to the outdoor environment. The condenser is known as the hot part of an air conditioner;

In the expansion valve, the pressure of the condensed fluid coming from the condenser falls abruptly, and consequently, so does the temperature of said fluid;

The evaporator has coils through which the fluid circulates. The hot air coming from the indoor environment to be cooled comes into contact with the cold coil and its temperature falls due to the heat exchange. An axial fan delivers the cooled air to the indoor environment. In the evaporator, the liquid part of this fluid evaporates and is transformed into gas, which in turn will be sent back to the compressor. The evaporator is known as the cold part of an air conditioner.

Thus, the heat is removed from the hot air of the indoor environment by the evaporator and transported to the condenser, where it is released to the outdoor environment. This process occurs in the pipes, coils and fins of the air conditioner, where the fluid which acts as one of the agents responsible for the heat exchange and transport circulates.

### The Change in the Air Humidity

In addition to the decrease in the temperature of the air coming from the indoor environment, the condensation of the humidity of said air also occurs on the surface of the evaporator, whose temperature should be lower than the dew point of the air for this condition to be possible. Thus, a common air conditioner removes air humidity in addition to cooling the environment.

In various situations, the removal or air humidity is desirable for an ideal comfort to be reached. However, in some cases, the continuous operation of the air conditioner results in very dry air, causing a feeling of discomfort to the people present in the environment, physically manifested mainly through coughs, throat irritation and, in more serious cases, breathing difficulty. This situation is very common in hot regions, where in the air conditioner is used continuously for prolonged periods of time.

### Prior Art Techniques

In order to prevent the air from becoming too dry, some alternative solutions have been adopted by air conditioner users themselves, such as, for example, putting a water container in the indoor environment to be cooled. This solution only alleviates the problem, since it is rather limited and has some drawbacks, as it takes up additional space, is unpractical and not very effective. Moreover, this solution is an implementation of an open-loop system, that is, it is not possible to automatically control (correct) the humidity level to reach the desired (stable) value which represents a comfort condition. In this kind of open-loop system, the humidity value is unstable and variable according to the conditions of the environment, such as, for example, the number of people present in the room, the constituent materials of the walls and windows, among other factors. Thus, the user cannot precisely determine the level of humidity which will be effectively reached with a certain adjustment or setting.

Other solutions consist in using the water condensed in the air conditioner evaporator or condenser in the humidification process. In this technique, the residual water resulting from the condensation in the evaporator or condenser, which would normally be disposed of in the outdoor environment, is reused and directed to an element or device which is able to add humidity to an environment. A disadvantage of this method is that it is a passive form of humidification, that is, its effectiveness is dependent on the level of humidity of the air that passes through the evaporator or condenser, according to the mode of use of the product (cold or heating mode). If the level of humidity of the air is not sufficient, little water is condensed and, consequently, an insufficient amount of water can jeopardize the humidification performance. Additionally, as in the previous case, this is an open-loop system.

Another disadvantage of many air conditioners having the humidification function is that the humidification is only possible if the compressor is turned off. This limits the usability of the humidification module, which is characterized by being dependent on the operation of the air conditioner.

In view of the above, document MU 8403175-1 describes an embodiment in which a humidification apparatus having a nebulizing element is coupled to ordinary air conditioning equipment. In order to install said system, modifications and adaptations need to be made to the structure of the air conditioning equipment so as to enable the coupling and fitting to be carried out. Thus, said need is a disadvantage when compared to a built-in solution, in which the humidification module is factory installed in the air conditioning equipment, and no interference by the user is necessary. This apparatus further comprises a water reservoir which can be refilled manually through an opening or automatically with the water condensed in the evaporator. However, the solution described in this document does not disclose an embodiment which enables the humidification apparatus to be easily removed so as to facilitate the cleaning and maintenance thereof.

Thus, there is a need for air conditioning equipment capable of controlling the level of relative air humidity through a closed-loop system, enabling a stable relative air humidity level to be obtained for a pre-adjusted value. The invention is directed to these, and other, important needs.

### SUMMARY OF THE INVENTION

In one aspect, the invention is directed to air conditioning equipment comprising at least one cooling system and a humidification module connected to each other, the humidification module being built into the air conditioning equipment and capable of being controlled independently from the cooling system, through at least one electronic sub-module.

### BRIEF DESCRIPTION OF THE DRAWINGS

The present invention will be described below in more detail, with reference to the attached drawings, in which:

FIG. 1—represents a view in perspective of an air conditioner, the subject of the present invention, having a first embodiment of a humidification module;

FIG. 2—represents a view in perspective of the humidification module illustrated in FIG. 1;

FIG. 3—represents an exploded view in perspective of the humidification module illustrated in FIG. 1;

FIG. 4—represents a cross-sectional view in perspective of the humidification module illustrated in FIG. 1.

FIG. 5—represents a frontal cross-sectional view of the humidification module illustrated in FIG. 1.

FIG. 6—represents a view in perspective of the humidification module illustrated in FIG. 1, with emphasis on the water refill lid in its closed position.

FIG. 7—represents a view in perspective of the humidification module illustrated in FIG. 1, with emphasis on the water refill lid in its open position.

FIG. 8—represents a view in perspective of the air conditioning equipment, the subject of the present invention, with emphasis on a filling tube.

FIG. 9—represents a view in perspective of the air conditioning equipment, the subject of the present invention, with emphasis on its lower portion and on the drainage chute.

FIG. 10—represents a partially exploded view in perspective of the air conditioning equipment, the subject of the present invention, with emphasis on its lower portion and on the drainage means;

FIG. 11—represents a view in perspective of an air conditioner, the subject of the present invention, having a second embodiment of the humidification module, with emphasis on a water filling drawer;

FIG. 12—represents a view in perspective of the air conditioning equipment illustrated in FIG. 11, with emphasis on the water filling drawer of the humidification module in the open position.

### DETAILED DESCRIPTION OF ILLUSTRATIVE EMBODIMENTS

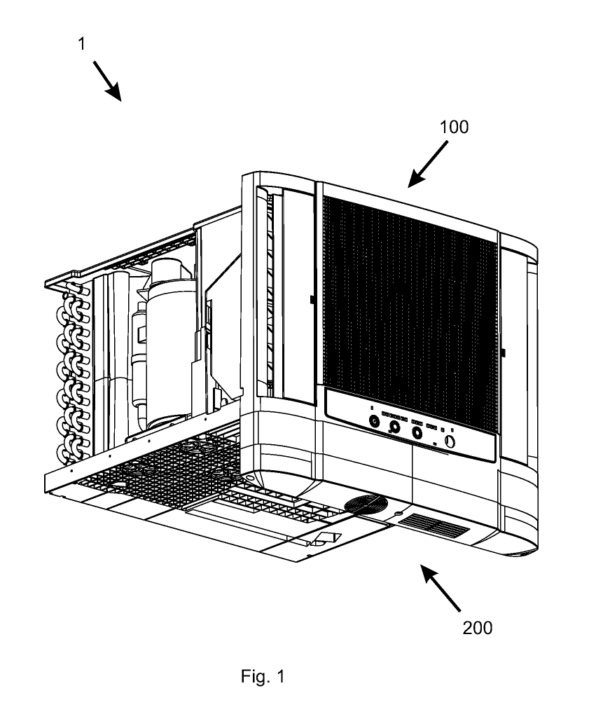

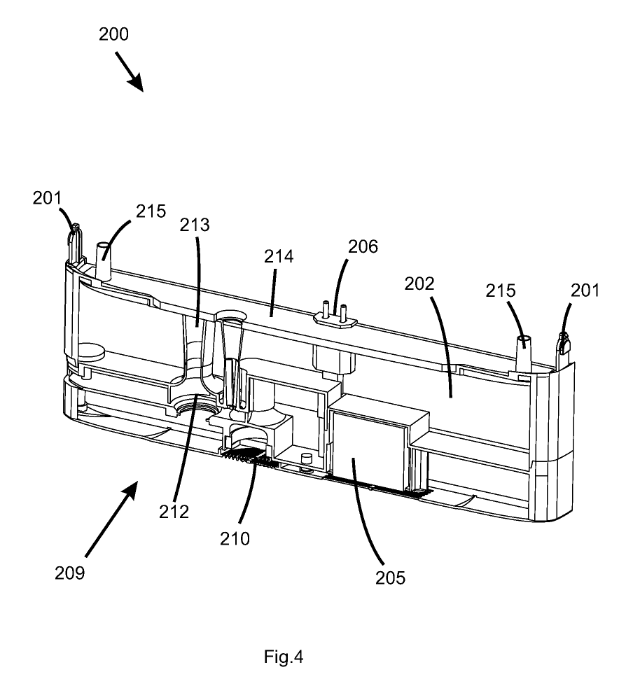

FIG. 1 illustrates an air conditioner 1, comprising a cooling system 100 and a humidification module 200 connected to each other, the humidification module 200 being removably connected to the cooling system 100. Said connection is possible through two fitting elements 201, shown in FIG. 4, arranged in a upper portion of the humidification module 200, enabling the humidification module 200 to be positioned under the cooling system 100, forming the frontal panel of the air conditioning equipment 1. Evidently, another number of fitting elements 201 and/or another positioning arrangement could be used, provided a secure and stable coupling is maintained.

The humidification module 200 is of the built-in type, that is, the humidification module 200 is part of the air conditioning equipment 1. In other words, the humidification module 200 is installed/mounted on the air conditioning equipment 1 during the process of manufacture of the product. Usually, with this kind of solution the production costs are reduced and the resources are optimized when compared to a non-built-in solution, in which the air conditioning equipment 1 is not designed to receive a humidification module 200. Furthermore, in the built-in solution, no unforeseen subsequent alteration to the structure of an ordinary air conditioning equipment is necessary.

Thus, it can be said that the humidification module 200 is removably built-in to the air conditioning equipment 1. This functionality (the ability to remove the humidification module 200) enables simple and easy cleaning, since the user does not need to use any special tool and no in-depth technical knowledge/training is necessary to perform said operation. In case of an operational failure which requires technical maintenance by a specialist, all the user needs to do is to remove the humidification module 200 and take it to a technician.

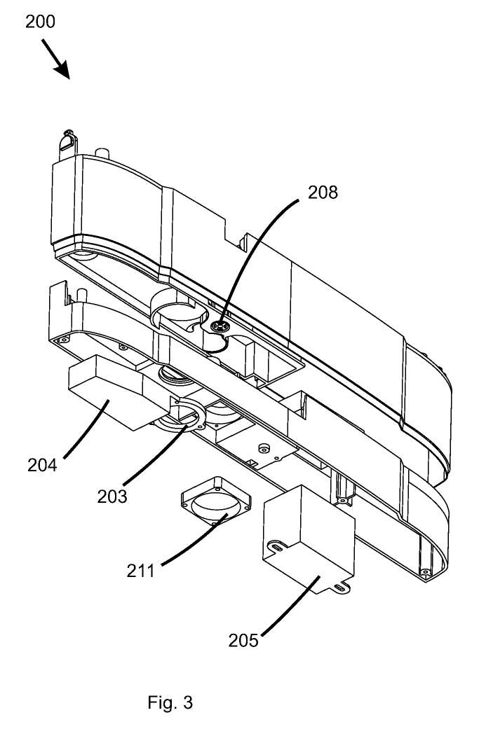

The humidification module 200 comprises at least one water reservoir 202 and an atomizing element 203, illustrated in FIGS. 3 and 4. Said atomizing element 203 is capable of nebulizing the water contained in the water reservoir 202, producing water mist which, when released in an indoor environment, increases the relative air humidity of said environment. Preferably, the atomizing element 203 is a piezoelectric cell (piezoelement) capable of providing the nebulization of water through ultrasonic cavitation, responsible for the formation of cavities or bubbles in a liquid, containing variable amounts of gas, obtained by applying electrical stimulation to the piezoelectric cell (piezoelement). For example, the piezoelement manufactured by AUDIOWELL Electronics, model AW16Y20120G2 N^{o} Fog 06015 is compatible with this application.

The operation of the atomizing element 203 is actively controlled by the user through at least one electronic sub-module 204, shown in FIG. 3. Thus, the electronic sub-module 204 enables the control of the atomizing element 203 by the user to stably reach preestablished levels of relative air humidity. Said control is of the closed-loop type, that is, the humidity value is automatically adjusted and corrected until a stable level is reached, regardless of variations in the environment. Preferably, the electronic sub-module 204 comprises a microprocessor having a program which is able to monitor and control the value of humidity for a condition desired by the user by a suitable algorithm, which enables higher precision, flexibility and functionality. The electronic sub-module 204 preferably comprises a sensor or humidity transducer (not illustrated in the figures) capable of measuring the humidity value at a certain moment and of sending this value, converted into an analog electrical value, to the microprocessor or to some other electronic component which is able to convert the analog value into a digital value by the microprocessor. Optionally, the sensor can be arranged in any compartment of the humidification module 200, not necessarily inside the electronic sub-module 204.

Therefore, it is a robust system, in which the humidity is actively controlled and the desired humidity value is always reached, even in adverse environmental conditions. In the passive solutions, the user is not sure whether the humidification will occur in a satisfactory manner, since in addition to the fact that the precise adjustment of the humidity value is not possible, the variations in the environmental conditions can adversely affect the humidification performance, and oftentimes the humidity does not reach the desired comfort value due to this limitation of the passive systems.

The humidification module control 200 is independent from the operation of the cooling system 100, that is, the air conditioning system 1 does not need to be operating in cooling mode to activate the humidification module 200. Thus, if the user only wishes to increase the relative air humidity of the room (indoor environment) without altering its temperature, all he or she needs to do is to turn on the humidification module 200 and keep the other functions relating to temperature control off. Evidently, the contrary is also possible, that is, it is possible to turn on only the cooling system 100 and keep the humidification system module 200 off. Finally, it is also possible to simultaneously activate the cooling system 100 and the humidification module 200 in case the user wishes to simultaneously adjust the temperature and the relative air humidity of the room.

Preferably, the user controls the humidification module 200 by a remote control apparatus, through an infrared-based communication system. The user can adjust the exact humidity value or choose from the preset factory settings (temperature and/or humidity comfort adjustment programs).

This independence and the selective activation ability of the air conditioning equipment 1 are possible because the operation of the atomizing element 203 is not affected by the temperature or by the relative air humidity of the room, and the only requirement is that the water reservoir 202 is filled with a minimum amount of water. Thus, the electronic sub-module 204 is able to act on the atomizing element 203 based on an independent control logic, which does not vary with the operation of the cooling system 100. This characteristic also represents an advantage when compared to the humidification systems whose operation is dependent on the other parts of the air conditioning equipment 1, restricting the usability, giving the user fewer operation options.

The electronic sub-module 204 is electrically fed by the transformer 205 which is able to convert an alternating voltage into a continuous voltage which is compatible with the electronic sub-module 204. This continuous voltage is also used for the electric supply of the atomizing element 203 (piezoelectric cell). An electrical connector 206 arranged at the upper portion of the humidification module 200 is able to provide alternating voltage from the cooling system 100 to the transformer 205.

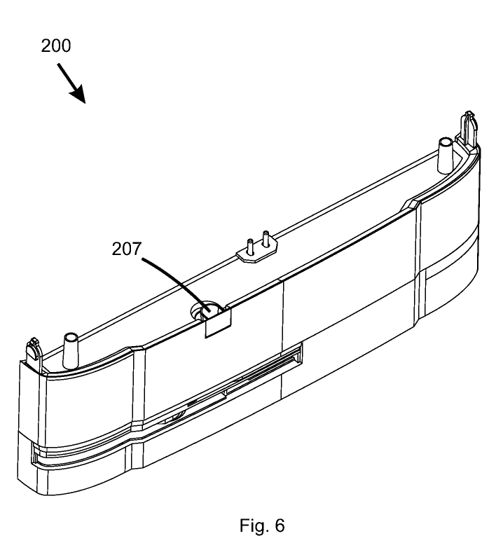

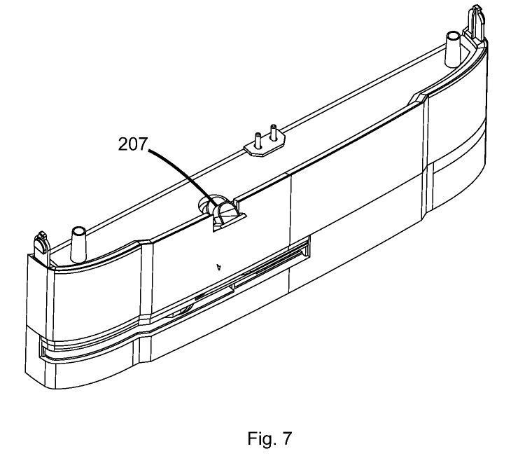

The water reservoir 202 comprises at least a water refill lid 207, illustrated in FIGS. 6 and 7, which can be manually opened or closed by the user without using special tools, thus enabling water to be refilled without removing the humidification module 200 of the air conditioning equipment 1. For example, a pitcher or any other water container can be used to refill the water reservoir 202 directly through the water refill lid 207 in the open position. During the normal operation of the humidification module 202, the water refill lid 207 should remain closed. Evidently, if the user wishes to do so, he or she can refill the water reservoir 202 by removing the humidification module 200. As previously described, the removal of the humidification module 200 also has the purpose of making its cleaning and maintenance easier and simpler.

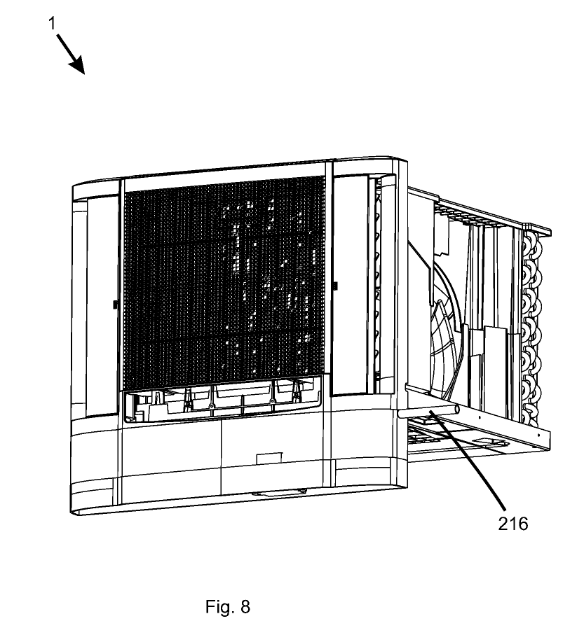

Alternatively, the water reservoir can be refilled by connecting a filling tube 216 to a suitable water supply (for example, a treated water tap), as shown in FIG. 8. This filling tube 216 can transport water from the tap or any other suitable water supply to the water reservoir 202. Thus, the user can refill the water reservoir 202 just by opening the tap, making this process even easier.

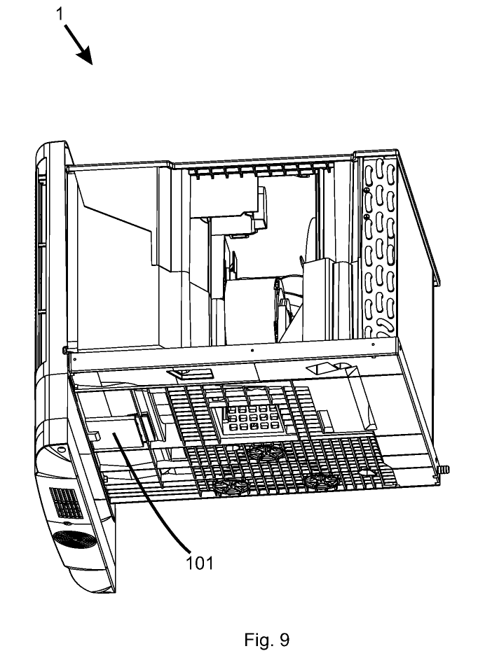

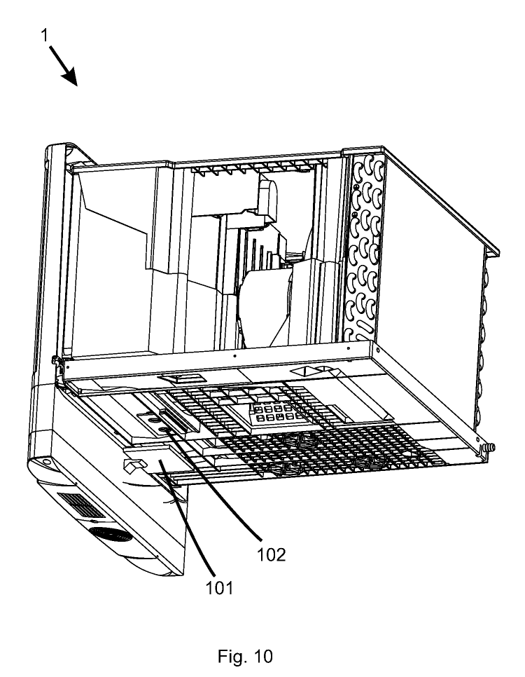

Optionally, the water can be provided by drainage means or a drain which is able to provide residual water from the cooling system 100 (for example, the water condensed in an evaporator of the air conditioning equipment 1) to the water reservoir 202, as shown in FIGS. 9 and 10. In a preferred embodiment, the drainage means, arranged in the cooling system 100 itself, comprises at least a drainage chute 101 connected to at least one drainage hole 102, and the drainage chute 101 is able to direct the residual water collected from the drainage hole 102 to the water reservoir 202.

Thus, this invention comprises different forms of refilling the water reservoir, providing a range of solutions to the user, who can choose the most suitable and functional one according to his or her needs.

Regardless of the refilling form, the water level in the water reservoir 202 should not be below a minimum amount so as not to damage the atomizing element 203, which should always operate with a minimum amount of water available. In order to prevent said damage, a water level sensor 208 is installed in the humidification module 200. The water level sensor 208 is connected to the electronic sub-module 204, which in turn is able to deactivate the atomizing element 203 when the water level sensor 208 indicates that the water level is below a preestablished safety value. This safety value can vary depending on the manufacturer, type and model of the atomizing element 203 used.

The water nebulized by the atomizing element 203 is transported and directed to the cooling system 100 by a transport subsystem 209.

Said transport subsystem 209 comprises at least one external air inlet 210 connected to a transport fan 211 (electrically fed by the transformer 205) capable of moving the external air provided by the outside air inlet 210 to an intake manifold 212, which in turn is able to direct the nebulized water and air mixture to a first passage duct 213. The first passage duct 213 takes the nebulized water and air mixture to a second passage duct 214, which in turn takes this mixture to humidification outlets 215. Finally, the humidification outlets 215 take the nebulized water and air mixture to the air outlet of the cooling system 100. Evidently, the amount and the position of the humidification outlets 215 can vary and are not limited to the arrangement shown in the figures.

The cooling system 100 comprises, in addition to the drainage chute 101 and to the drainage holes 102, the main elements of an air conditioner 1 as explained in the prior art, that is, the cooling system 100 has an evaporator, a condenser, a compressor, an expansion valve and fans, in addition to the pipes and fins. These elements form a cooling circuit through which a fluid flows so as to enable the temperature of an indoor environment to be decreased, by removing the heat from this environment and moving it to an outdoor environment through the constitutive elements of the air conditioning equipment 1 involved.

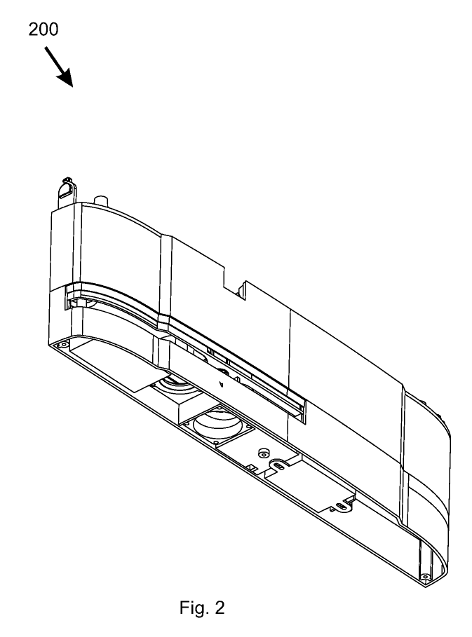

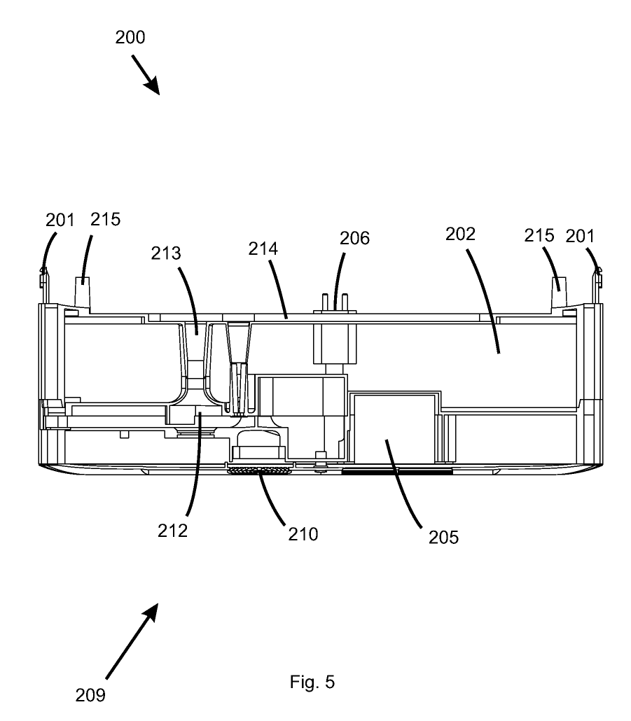

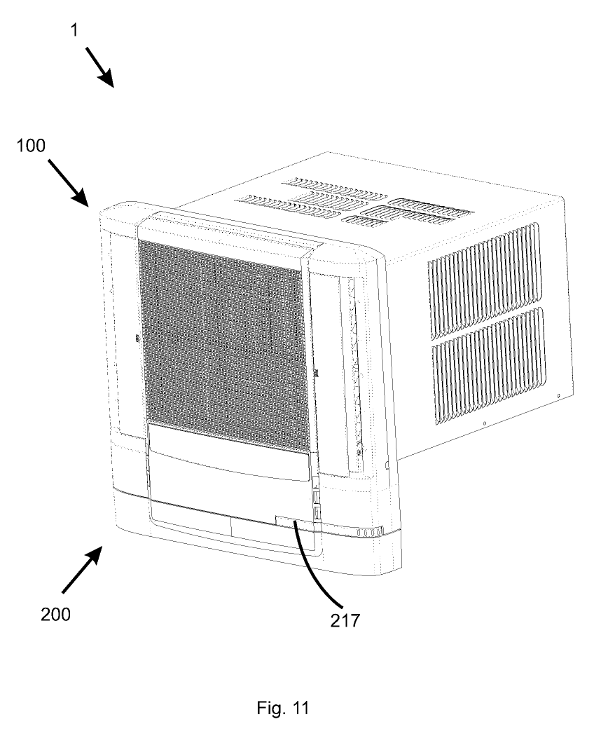

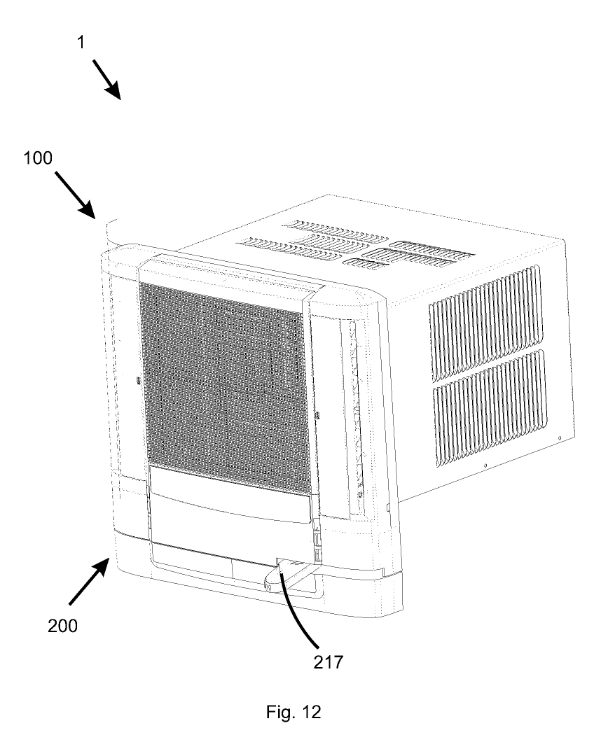

FIGS. 11 and 12 show the air conditioning equipment 1 having a second embodiment of the humidification module 200, and in this variation the water reservoir 202 is under the electronic set (transformer 205, the electronic sub-module 204, the atomizing equipment 203 etc.), differently from the first embodiment, illustrated in FIGS. 1 to 10, in which the water reservoir 202 is above said electronic set. This second embodiment has an advantage regarding the safety of the user, since the risk of contact between the user and the electronic components is avoided. Preferably, a water pump (not illustrated in the figures) is installed in this humidification module to transport water to the atomizing element 203, which is above the water reservoir 202 in this second embodiment.

FIG. 12 shows a water filling drawer 217 of the second embodiment of the humidification module 200 in the open position in order to enable water to be filled in directly by the user, without the need to remove the humidification module 200. In FIG. 11, which shows the humidification module 200 in operation, the water filling drawer 217 is closed.

Having described a preferred embodiment, it should be understood that the scope of the present invention encompasses other possible variations, being limited only by the content of the appended claims, including the possible equivalents thereof.

What is claimed:

1. Air conditioning equipment comprising at least one cooling system and a humidification module connected to each other, wherein the humidification module is removably built into the air conditioning equipment and is controllable independently from the cooling system through at least one electronic sub-module.

2. Air conditioning equipment according to claim 1, wherein the humidification module comprises at least one water reservoir.

3. Air conditioning equipment according to claim 2, wherein the humidification module comprises at least one atomizing element which is able to nebulize the water contained in the water reservoir.

4. Air conditioning equipment according to claim 3, wherein the electronic sub-module comprises at least one microprocessor which enables the atomizing element to be controlled to reach preestablished stable levels of relative air humidity.

5. Air conditioning equipment according to claim 2, wherein the humidification module comprises at least one water refill lid which can be opened or closed to enable the water reservoir to be refilled.

6. Air conditioning equipment according to claim 2, wherein the humidification module comprises at least one filling tube which is able to transport water from a water supply to the water reservoir

7. Air conditioning equipment according to claim 2, wherein the cooling system has drainage means which are able to provide residual water from the cooling system to the water reservoir said drainage means comprising at least one drainage chute associated to at least one drainage hole, the drainage chute being able to direct the residual water collected from the drainage hole to the water reservoir.

8. Air conditioning equipment according to claim 3, wherein the humidification module (200) comprises at least one water level sensor associated to the electronic sub-module, said electronic sub-module being able to deactivate the atomizing element when the water level sensor indicates that the water level is below a preestablished safety value.

9. Air conditioning equipment according to claim 3, wherein the atomizing element is a piezoelectric cell capable of providing water nebulization through the principle of ultrasonic cavitation.

10. Air conditioning equipment according to claim 3, wherein the humidification module comprises at least one transport subsystem which is able to transport and direct the water nebulized by the atomizing element to the cooling system.

11. Air conditioning equipment according to claim 10, wherein the transport subsystem comprises at least one outside air inlet associated to a transport fan which is able to move the outside air to an intake manifold, said intake manifold being able to direct the nebulized water and air mixture to a first passage duct, said first passage duct being able to take the nebulized water and air mixture to a second passage duct, said second passage duct being able to take the nebulized water and air mixture to at least one humidification outlet connected to the air outlet of the cooling system.

12. Air conditioning equipment according to claim 1, wherein the humidification module is removably associable to the cooling system by at least one fitting element.
